(19) United States
(12) Patent Application Publication
(10) Pub. No.: US 2017/0124542 A1
(43) Pub. Date: May 4, 2017

(54) Methods and Systems for Dispensing Physical Currency

(71) Applicant: MASTERCARD INTERNATIONAL INCORPORATED, Purchase, NY (US)

(72) Inventor: ASHUTOSH SHARAN, Gurgaon (IN)

(21) Appl. No.: 15/339,247

(22) Filed: Oct. 31, 2016

(30) Foreign Application Priority Data
Nov. 4, 2015 (SG) 10201509087Q

(51) Int. Cl. G06Q 20/10; G06Q 20/40; G06F 17/30

(52) U.S. Cl. CPC G06Q 20/102; G06F 17/30424; G06Q 20/40; G06Q 20/1085

(57) ABSTRACT

An automatic method and computerized network is provided to provide physical currency to an individual who desires it. The individual submits a request for physical currency, and is automatically provided with sufficient information to meet a currency-provider (an individual or a company) who is willing to provide the physical currency to the individual in exchange for a payment being made to a payment account associated with the currency-provider. In this way, the individual is able to obtain physical currency even in the absence of an ATM. Accordingly, the need for financial institutions to provide ATMs is reduced, and the costs associated with providing ATMs can be saved.

### SUMMARY OF THE INVENTION

The present invention relates to methods and systems for providing individuals with physical currency, such as banknotes and/or coins, commonly referred to as “cash”.

### BACKGROUND OF THE INVENTION

Cashless transactions are becoming increasingly common in the modern world. Despite that, individuals use physical currency for a variety of reasons, such as making payments to other individuals or organizations which are not yet enabled to receive a cashless transaction. For this reason, financial institutions such as banks provide automated teller machines (ATMs) at which individuals can obtain physical currency, typically using a payment card associated with the individual. Often this is provided as a “free service”, even to customers of other financial institutions, despite the significant cost of running an ATM. These costs take several forms. First, there is the cost of the space which the ATM occupies (e.g. a rent which the financial institution has to pay to the owner of the premises where the ATM is located). Additionally, the ATMs must be regularly provided with physical currency, which requires security staff to visit the machines and spend time replenishing them. Then there is the cost of the ATMs themselves, which is high since they must be prepared to withstand attacks by thieves. Such attacks do nevertheless occur, so the financial institution will occasionally incur the expenses of repairing the machines and, in some cases, losing the currency stored within them.

It may happen that an individual finds himself or herself in a location where no functioning ATM exists which is compatible with his or her payment card, and thus the individual is unable to obtain the physical currency which he or she desires.

### SUMMARY OF THE INVENTION

The present invention aims to provide new and useful systems and methods for dispensing physical currency to individuals, and preferably methods and systems which address the problems of conventional systems and methods noted above.

In general terms, the invention proposes that an individual who wishes to obtain physical currency is automatically provided with sufficient information to meet a currency-provider (an individual or a company) who is willing to provide physical currency to the individual in exchange for a payment being made to a payment account associated with the currency-provider. In this way, the individual is able to obtain physical currency even in the absence of an ATM. Accordingly, the need for financial institutions to provide ATMs is reduced, and the costs associated with providing ATMs can be saved.

The individual is typically associated with (e.g. carries and typically owns) a communication device (such as a smartphone or a tablet) which carries software (an application) which enables the communication device to issue a request for physical currency. The request typically includes data specifying the amount of physical currency requested.

The request may be directed by the communication device to a server of a bank which maintains a payment account (bank account) associated with the individual. This bank is referred to in this document as an issuing bank. Alternatively, in other embodiments, the request may be directed to a server separate from the issuing bank (e.g. operated and/or owned by a different commercial organisation) which forwards the request to a server of the issuing bank.

The request includes data which specifies the payment account associated with the individual. For example, the request may include a number of the payment account, or payment card data of a payment card associated with the account. In either case, this data may have been entered by the individual when initiating the request, or the data may be pre-stored in the communication device (e.g. because the user has entered it earlier). Alternatively, the account number or payment card data may be pre-stored in a database accessible by server which receives the request, and which the server is able to access using other data in the request (e.g. if the request identifies the communication device, the server may be able to access a database of payment account information associated with respective communication devices to find the payment account details corresponding to the individual's communication device).

In response to the request, the issuing bank performs a payment authorization process. This may be for an amount of physical currency indicated in the payment request.

If the authorization process is successful, a server (which may again be a server of the issuing bank or alternatively a commercially-separate server referred to below as an ATM marketplace server) carries out a process which puts the individual in contact with a currency provider in a locality of the individual.

Preferably, in response to the request, the server performs a search operation to identify at least one currency provider meeting one or more criteria, including the criterion of being in the locality of the individual.

Optionally, the server may send a message to the identified currency providers (typically specifying the amount of physical current which has been requested), and eliminate any of the identified currency providers who do not reply with an acceptance message (e.g. within a certain time period).

Optionally, if a plurality of currency providers meeting the one or more criteria are identified by the server, the server provides the communication device with details of one or more of the currency providers meeting the criteria, for the individual to select a single one of the currency providers. Alternatively, the server may make a selection itself, e.g. as noted below, the currency providers may be paid a fee for providing physical currency, and if so the server may select the single currency provider meeting the one or more criteria and charging the lowest fee. Alternatively the number of the currency providers presented to the communication device may be limited by a preference of the individual, which is stored in the settings of the communication device. In yet another embodiment the number of currency providers may be limited by the space available on the screen of the communication device.

Once a currency provider has been selected, the server initiates an instruction to the selected currency provider to provide physical currency to the individual. This may be by a direct instruction, from the server to the currency provider. Alternatively, the server may communicate with an acquiring bank (also called an acquirer) where the selected currency provider maintains a payment account (bank account), and that the acquiring bank may issue the instruction to the selected currency provider.

Having received the instruction, the selected currency provider provides the physical currency to the individual, and the individual and/or the selected currency provider confirms to the server and/or the receiving bank that this has been done. A payment is then arranged to the payment account at the receiving bank associated with the selected currency provider.

The payment is typically for at least as large an amount as the provided physical currency, but may additionally comprise a service fee which rewards the selected currency provider for providing the currency. In one option, some or all of the service fee may be paid by the individual (e.g. charged to his payment account with the issuing bank). Alternatively, some or all of the service fee may be provided by one or more of the financial institutions involved (i.e. the issuing bank or the acquiring bank). In other words, if, by means of the invention, the financial institutions involved avoided the need to provide and run an ATM, the selected currency provider may obtain a part of the institutions' consequent saving. However, note that alternative embodiments are possible in which the selected currency provider receives only a payment for the same value as the physical currency given to the individual, or even a sum which is slightly less than the physical currency it provided to the individual. This recognises the fact that the selected currency provider may be an organisation which tends to accumulate more physical currency than it wishes (e.g. a shop which receives payments in physical currency), and might be prepared to pay a fee to exchange its excess physical currency for a sum in its bank account.

As used in this document, the term “payment card” refers to any cashless payment device associated with a payment account, such as a credit card, a debit card, a prepaid card, a charge card, a membership card, a promotional card, a frequent flyer card, an identification card, a prepaid card, a gift card, and/or any other device that may hold payment account information, such as mobile phones, Smartphones, personal digital assistants (PDAs), key fobs, transponder devices, NFC-enabled devices, and/or computers.

The term “automatic” is used to mean a process substantially without human involvement, except for initiation of the process, and optionally except for the individual to select one of a number of options. The term “computerized network” is used to refer to a plurality of electronic computing devices which communicate via one or more telecommunication networks, such the internet. The computing devices are typically not all owned or operated by a single party.

The invention may be expressed as a method for providing physical currency to an individual, or as a computerized network for performing the method. It may further be expressed as a server or communication device which is a component of the network. It may further be expressed as a computer program product (e.g. one stored in the form of non-transitory computer program instructions stored on a tangible recording medium) which can be run by a processor of a communication device, to cause the communication device to participate in the method.

### BRIEF DESCRIPTION OF THE DRAWINGS

An embodiment of the invention will now be described for the sake of example only with reference to the following drawings, in which:

FIG. 1 shows schematically a computerized network of electronic devices for performing a method which is an embodiment of the invention, and incorporating a server which is an embodiment of the invention;

FIG. 2 is a flow diagram of a set-up procedure for an individual's communication device which is a part of the network of FIG. 1;

FIG. 3 is a flow diagram of a set-up procedure for a currency-provider's communication device which is a part of the network of FIG. 1;

FIG. 4 is a flow diagram of the method performed by the payment network of FIG. 1;

FIG. 5 is a block diagram of the technical architecture of the server of FIG. 1; and

FIG. 6 is a block diagram of a communication device which is part of the network of FIG. 1.

### DETAILED DESCRIPTION OF THE EMBODIMENTS

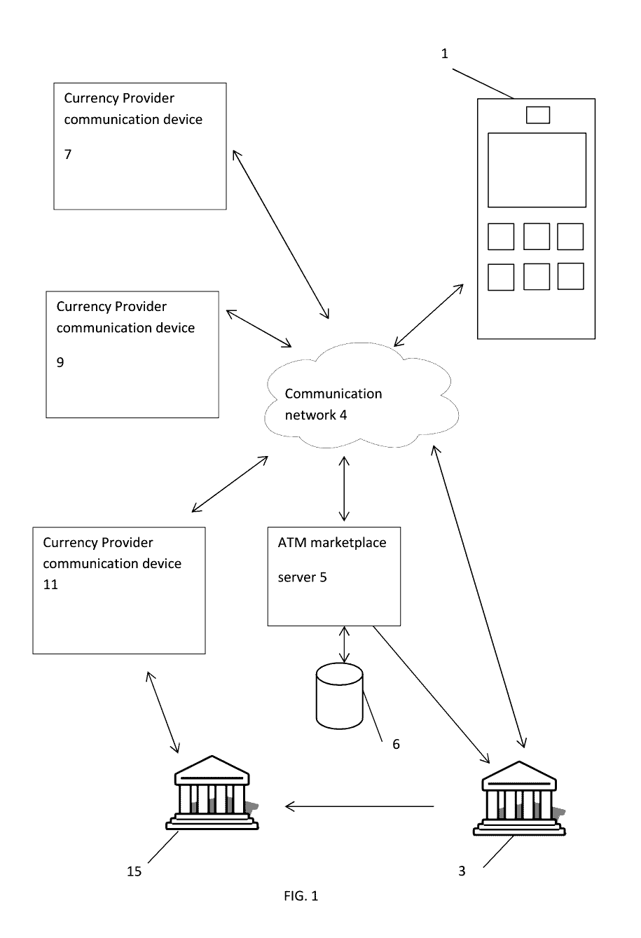

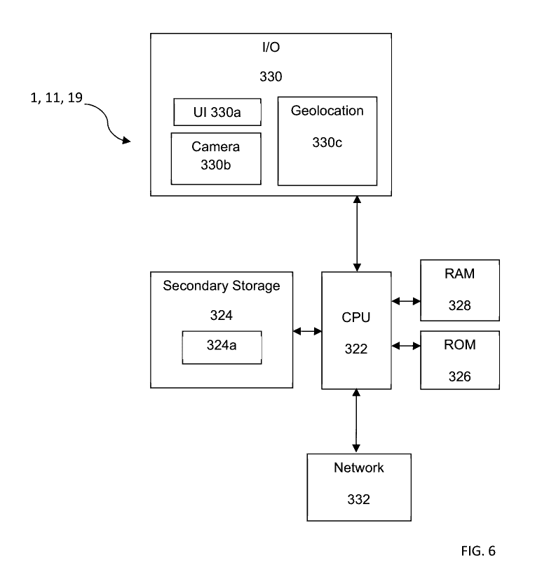

Referring firstly to FIG. 1, a computerized network of electronic devices is shown which is arranged to perform a method according to the invention. The network includes a communication device 1 (such as a smartphone or tablet computer) associated with an individual. The communication device 1 is typically a mobile device. As described below with reference to FIG. 6, the communication device 1 includes a memory storing a software application, and payment account information identifying a payment account associated with the individual and held by an issuing bank which operates a server 3. The payment account information may be in the form of payment card data, such as data printed on a physical payment card associated with the payment account.

The communication device 1 is arranged to communicate via a communication network 4 (such as the internet) with an ATM marketplace server 5, which has access to a database 6. The database 6 stores information about a set of communication devices (including the communication device 1) associated with respective individuals. Optionally, the database stores additional security information associated with the individual, such as a password known to the individual and/or biometric data relating to the individual.

The database 6 further stores details (including contact details) of communication devices 7, 9, 11 associated with a respective plurality of individuals/organisations (“currency providers”) which are prepared to issue physical currency. Although only three such devices 7, 9, 11 are illustrated, in reality there will be at least a hundred, at least a thousand or at least 10,000 such devices, distributed geographically across a wide region, such as a state or a country.

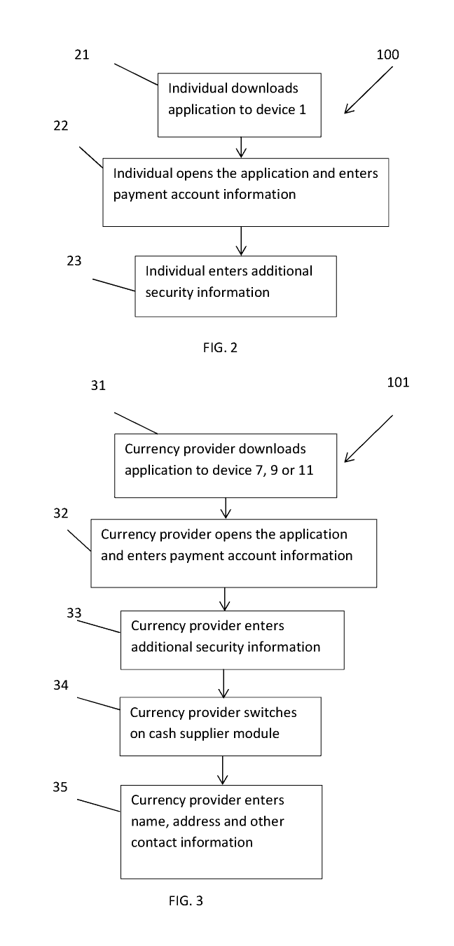

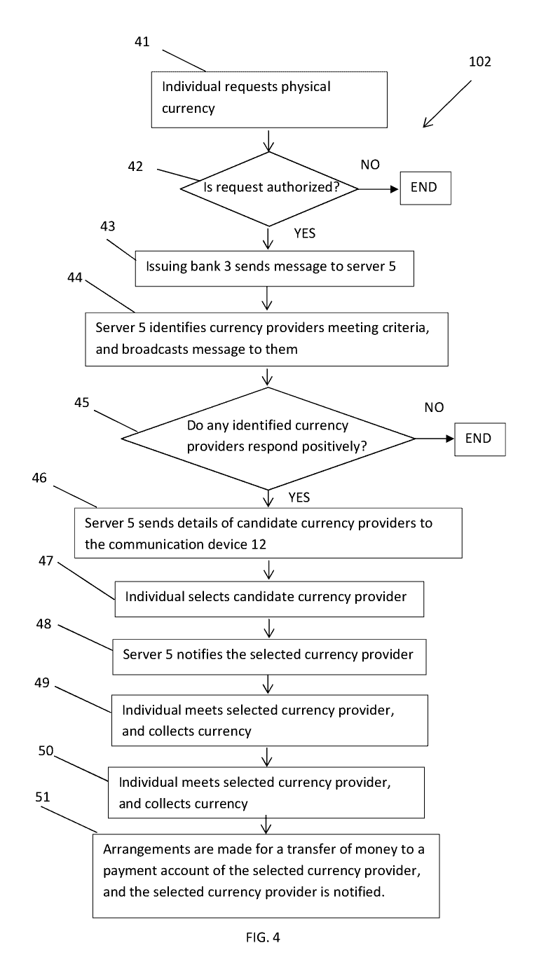

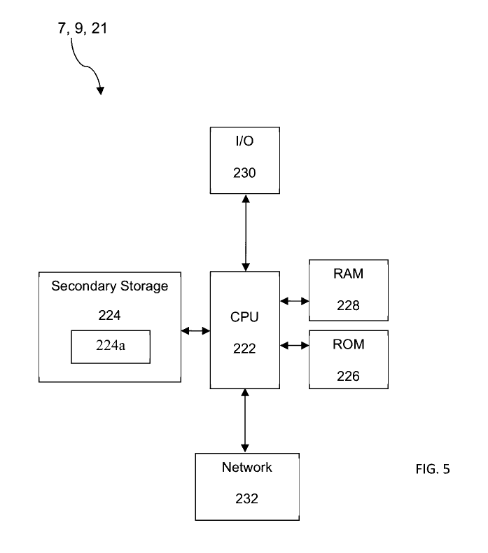

Turning to FIG. 2, the steps are shown of set-up procedure 100 for communication device 1 the network of FIG. 1, while FIG. 3 shows the steps of the set-up procedure 101 for the communication devices 7, 9, 11 of the currency providers. FIG. 4 shows the steps of a method 102 carried out by the network following the set-up procedures.

In step 21 the individual controls the communication device 1 to download the software application over the communication network 4. In one possibility, the download may be from the server 5. Alternatively, the download may be from the server 3 associated with the issuing bank 3.

In either case, before the download begins a check may be done of whether the communication device 1 has previously been registered with the issuing bank, and the download may only proceed if this is the case. The check may be done for example using identity data of the communication device 1 which is included in a request to download the software application. If the result of the check is negative, then optionally the software application may be downloadable by following an additional layer of security, such as by obtaining from the issuing bank 3 (e.g. by telephone) a unique authorization code; the authorization code is submitted by the individual to the issuing bank 3 via the communication device 1 in order to enable the download of the application to the communication device 1.

In step 22, the individual opens the software application, and types into it financial information associated with a payment account, such as the details of a payment card associated with the payment account. In one alternative, the financial information is stored (e.g. encrypted) on the communication device 1. In another alternative, the communication device 1 may store a token which is associated with the financial information. The token may be associated with the financial information in a database (such as a database accessible by the issuing bank server 3, or the database 6), such that the token can be used to retrieve the financial information.

In step 23, the individual further enters additional security information. For example, the communication device 1 may obtain biometric data from the user, such as by performing a fingerprint scan or a retinal scan, and/or the user may define a secret password. The function of the additional security information is to prevent the method of FIG. 4 being carried out if the communication device 1 is stolen by another individual.

Turning to FIG. 3, the steps are shown of the set-up procedure 101 carried out by a person or organisation which wishes to act as a currency provider, and which operates one of the respective communication devices 7, 9, 11. Steps 31-33 are the same as steps 21-23 of method 100. The application downloaded in step 31 is the same application downloaded in step 21 of procedure 100: that is, once steps 31-33 have been completed, the prospective currency provider can also use the application to request cash from other currency providers. Note, however, that in a variation of the embodiment, procedure 100 may use a first application, and procedure 101 may use a second application which is only usable to register as a currency provider, not as an individual who can submit requests for physical currency.

In step 34 the prospective currency provider switches on a cash provider module of the downloaded application. (Alternatively, if as mentioned in the preceding paragraph a dedicated currency provider application was downloaded in steps 31-33, this step may be unnecessary).

In step 35, the server 5 uses the payment account information obtained at step 32 to obtain, from the receiving bank supporting the payment account, information about the prospective currency provider, such as his/her name, address and, typically, other contact information such as their phone number (and/or optionally email address). Typically, steps 34 and 35 are performed before the method 102 (explained below with reference to FIG. 4) is performed. However, alternatively, steps 34 and 35 may be performed at a later time, as explained below.

Turning to FIG. 4, the method 102 performed by the network of FIG. 1 is illustrated. In step 41 the individual uses the downloaded application on the communication device 1 to issue a request to the issuing bank 3 associated with the payment account for physical currency. The request includes the amount of physical currency requested, the location of the device 1 (which the application may optionally obtain automatically, such as from an inbuilt global positioning system (GPS) of the communication device 1; or which the user may specify).

Furthermore the request includes enough information to identify the payment account associated with the user. Specifically if, as discussed above, the financial information is stored on the communication device 1 (e.g. encrypted) it may be included in the request. Alternatively, the request may include the identity of the communication device 1, and the issuing bank 3 may identify the financial account as one associated with the communication device 1. Alternatively, if the financial information has been stored in an external database and indexed with token stored on the communication device 1 (or entered by the individual as part of generating the request), the request may include that token.

In step 42, the issuing bank server 3 of the issuing bank associated with the individual's payment account determines whether to authorize request, e.g. by checking whether it is for an amount less than an available balance of the payment account. If the issuing bank server 3 refuses to authorize the payment, the issuing bank server 3 notifies the individual using the application on the communication device 1, and the method terminates.

Conversely, if the issuing bank server 3 authorizes the payment, in step 43 the issuing bank server 3 sends a message to the server 5. The message includes the authorized amount of physical currency. It may further include some identification information which can be used to identify the communication device 1 to a currency provider (see step 50 below). For example, the information may be a one-time token, for example in the form of a QR (quick response) code which can be displayed on a screen of the communication device 1 Optionally, the QR code might encode further information related to the transaction, such as the requested amount of physical currency.

In step 44, the server 5 identifies, using its database 6, one or more of the currency providers which meet one or more criteria. A first criterion may be that their location is within a certain distance of the location of the individual. Optionally, the location of the currency provider may be determined from the data supplied in step 35; alternatively, it may be obtained automatically using a GPS positioning device in the communication devices 7, 9, 11. Optionally, each of the currency providers may have previously indicated to the server 5 during the set-up procedure 101 that they will never provide more than a certain amount of physical currency; if so another criterion may be that this amount they are willing to dispense an amount of physical currency as high as the amount of physical currency requested by the individual. Another possible criterion may be whether the time at which the method is carried out is within a time window associated with the currency provider (e.g. within a set of office hours previously specified by the currency provider).

Having identified the currency providers meeting the one or more criteria, the server 5 sends a message (push notification) to them. Optionally, the message is sent only to currency providers who have already performed both of steps 34 and 35. Alternatively, the message may be pushed to potential currency providers who have performed only step 34, and these currency providers may be able to view the message and decide then whether to perform step 35.

In step 45, one or more of the identified currency providers who received the message send the server 5 a reply which is an acceptance message. These currency providers are termed “candidate currency providers”. Alternatively, it may be that none of the identified currency providers send any reply (e.g. within a predetermined period), or send a reply which is a decline message. In that case, the server 5 terminates the procedure, and informs the communication device 1 and/or issuing bank server 3; the method then ends. In a variation of the embodiment, if there are no candidate currency providers, the server 5 may revert to step 44 and relax the one or more criteria to find additional potential currency providers. Alternatively, since one reason why the currency providers who received the message did not accept may be that the requested amount of currency is greater than the amount which they had available, the server 5 may split the requested currency up into a plurality of smaller amounts, and then revert to step 44 treating the one request for physical currency as a plurality of separate requests for the respective smaller amounts. In this case, it may be possible to find a plurality of the currency providers who, collectively, are prepared to provide the amount of currency requested by the individual. This process of treating the single request for a requested amount physical currency as a plurality of requests for smaller amounts may be performed only if certain criteria are met, such as the requested amount of physical currency being above a threshold. The server 5 may issue a message to the communication device 1 in advance to confirm that the individual does not object to visiting a plurality of currency providers, and only proceed if the individual uses the communication device 1 to send a message of agreement.

Assuming that in step 45, one or more of identified currency providers reply with an acceptance message, in step 46 the sever 5 sends the application on the communication device 1 data which the application displays to the individual on a screen. This data includes details of the candidate currency providers. The data may be presented in the form of a list, and/or as a map showing the respective locations of the currency providers. The data typically includes the name, address and contact data (e.g. phone number and/or email address) of the candidate currency providers. The application may display this information at once, or it may display the information in response to interaction from the individual (for example, if the individual selects one of the currency providers on a map presented by the application, the application may give more information about the selected currency provider).

In step 47, the individual selects one of the candidate currency providers (e. g. the one closest to the individual, or closest to a route he or she wishes to take). Let us assume that this is the currency provider associated with the communication device 11.

In step 48, the selected currency provider is notified by the server 5. The server sends the communication device 11 information to allow the communication device to recognise the individual using the identification information (see step 43 above).

In step 49, the individual goes to the location of the selected currency provider. (Note that alternatively the individual and selected currency provider may agree to meet at another location, such as the home of the individual.)

In step 50 the individual authenticates himself or herself to the selected currency provider, using the identification information. For example, the communication device 1 may display the token 1, and the communication device 7 verifies the token (e.g. using the information supplied by the server 5 in step 48). Optionally, the selected currency provider could also identify himself/herself to the individual, such as by displaying a second token received from the server 5 in step 48 which is verified by the communication device 1 (which may also have received the second token from the server 5 in step 48). The individual collects the currency, and confirms this to the application on the communication device 1, which sends a message to the server 5 and optionally also the issuing bank server 3. If the message is only to the server 5, then the server 5 sends a message to the issuing bank server 3 saying that the money has been collected. Alternatively or additionally, the selected currency provider may also send a message to the server 5 and/or the issuing bank.

The payment account of the selected currency provider is maintained by a receiving bank 15. Note that the server 5 obtained the details of the payment account and the receiving bank 15 at step 33 of procedure 101. The issuing bank server 3 is notified by the selected currency provider and/or the server 5 of the details of the selected currency provider's payment account and the receiving bank 15.

In step 50, the issuing bank server 3 communicates with the server 15 of the receiving bank at which the selected currency provider maintains the payment account, and arranges for a transfer to be made to the payment account associated with the selected currency provider (note that typically the transfer itself is not instantaneous; instead it occurs some time later as part of the regular clearing procedure), and the receiving bank credits the payment account of the currency provider with a corresponding amount of money. The payment (amount of money credited to the account of the currency provider) is typically for the amount of physical currency the currency providers gave the individual plus a service fee, which may depend upon the identity of the currency provider (as well as other factors, such as the amount of physical currency provided). The receiving bank server 15 sends a message to the communication device 11 telling the corresponding currency provider that the currency provider's account has been, or will be, credited with the payment, and the method terminates.

A debit is made to the payment account associated with the individual at the issuing bank. This debit is at least equal to the amount of physical currency the individual receives, and may also include some or all of the service fee.

FIG. 5 is a block diagram showing a technical architecture of the ATM marketplace server 5. The servers 3, 15 of the issuing bank and receiving bank may also have this technical architecture.

The technical architecture includes a processor 222 (which may be referred to as a central processor unit or CPU) that is in communication with memory devices including secondary storage 224 (such as disk drives), read only memory (ROM) 226, random access memory (RAM) 228. The processor 222 may be implemented as one or more CPU chips. The technical architecture may further comprise input/output (I/O) devices 230, and network connectivity devices 232.

The secondary storage 224 is typically comprised of one or more disk drives or tape drives and is used for non-volatile storage of data and as an over-flow data storage device if RAM 228 is not large enough to hold all working data. Secondary storage 224 may be used to store programs which are loaded into RAM 228 when such programs are selected for execution.

In this embodiment, the secondary storage 224 has an order processing component 224a comprising non-transitory instructions operative by the processor 222 to perform various operations of the method of the present disclosure. The ROM 226 is used to store instructions and perhaps data which are read during program execution. The secondary storage 224, the RAM 228, and/or the ROM 226 may be referred to in some contexts as computer readable storage media and/or non-transitory computer readable media.

I/O devices 230 may include printers, video monitors, liquid crystal displays (LCDs), plasma displays, touch screen displays, keyboards, keypads, switches, dials, mice, track balls, voice recognizers, card readers, paper tape readers, or other well-known input devices.

The network connectivity devices 232 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other well-known network devices. These network connectivity devices 232 may enable the processor 222 to communicate with the Internet or one or more intranets. With such a network connection, it is contemplated that the processor 222 might receive information from the network, or might output information to the network in the course of performing the above-described method operations. Such information, which is often represented as a sequence of instructions to be executed using processor 222, may be received from and outputted to the network, for example, in the form of a computer data signal embodied in a carrier wave.

The processor 222 executes instructions, codes, computer programs, scripts which it accesses from hard disk, floppy disk, optical disk (these various disk based systems may all be considered secondary storage 224), flash drive, ROM 226, RAM 228, or the network connectivity devices 232. While only one processor 222 is shown, multiple processors may be present. Thus, while instructions may be discussed as executed by a processor, the instructions may be executed simultaneously, serially, or otherwise executed by one or multiple processors.

Although the technical architecture is described with reference to a computer, it should be appreciated that the technical architecture may be formed by two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the technical architecture 220 to provide the functionality of a number of servers that is not directly bound to the number of computers in the technical architecture 220. In an embodiment, the functionality disclosed above may be provided by executing the application and/or applications in a cloud computing environment. Cloud computing may comprise providing computing services via a network connection using dynamically scalable computing resources. A cloud computing environment may be established by an enterprise and/or may be hired on an as-needed basis from a third party provider.

It is understood that by programming and/or loading executable instructions onto the technical architecture, at least one of the CPU 222, the RAM 228, and the ROM 226 are changed, transforming the technical architecture in part into a specific purpose machine or apparatus having the novel functionality taught by the present disclosure. It is fundamental to the electrical engineering and software engineering arts that functionality that can be implemented by loading executable software into a computer can be converted to a hardware implementation by well-known design rules.

FIG. 6 is a block diagram showing a technical architecture of any one the communication devices 1, 7, 9, 11. It is envisaged that in embodiments, the communication device 1 will be mobile communication device such as a smartphone or tablet device, but it may alternatively be a PC at the individual's home or office. The communication devices 7, 9, 11 may also be mobile communication devices, but may also be a PC or other communication device at a location associated with the corresponding currency provider.

The technical architecture includes a processor 322 (which may be referred to as a central processor unit or CPU) that is in communication with memory devices including secondary storage 324 (such as disk drives or memory cards), read only memory (ROM) 326, random access memory (RAM) 328. The processor 322 may be implemented as one or more CPU chips. The technical architecture further comprises input/output (I/O) devices 330, and network connectivity devices 332.

The I/O devices comprise a user interface (UI) 330a, a camera 330b and a geolocation module 330c. The UI 330a may comprise a touch screen, keyboard, keypad or other known input device. The camera 330b allows a user to capture images and save the captured images in electronic form. The geolocation module 330c is operable to determine the geolocation of the communication device using signals from, for example global positioning system (GPS) satellites.

The secondary storage 324 is typically comprised of a memory card or other storage device and is used for non-volatile storage of data and as an over-flow data storage device if RAM 328 is not large enough to hold all working data. Secondary storage 324 may be used to store programs which are loaded into RAM 328 when such programs are selected for execution.

In this embodiment, the secondary storage 324 has an order generation component 324a, comprising non-transitory instructions operative by the processor 322 to perform various operations of the method of the present disclosure. The ROM 326 is used to store instructions and perhaps data which are read during program execution. The secondary storage 324, the RAM 328, and/or the ROM 326 may be referred to in some contexts as computer readable storage media and/or non-transitory computer readable media.

The network connectivity devices 332 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other well-known network devices. These network connectivity devices 332 may enable the processor 322 to communicate with the Internet or one or more intranets. With such a network connection, it is contemplated that the processor 322 might receive information from the network, or might output information to the network in the course of performing the above-described method operations. Such information, which is often represented as a sequence of instructions to be executed using processor 322, may be received from and outputted to the network, for example, in the form of a computer data signal embodied in a carrier wave.

The processor 322 executes instructions, codes, computer programs, scripts which it accesses from hard disk, floppy disk, optical disk (these various disk based systems may all be considered secondary storage 324), flash drive, ROM 326, RAM 328, or the network connectivity devices 332. While only one processor 322 is shown, multiple processors may be present. Thus, while instructions may be discussed as executed by a processor, the instructions may be executed simultaneously, serially, or otherwise executed by one or multiple processors.

Whilst the foregoing description has described exemplary embodiments, it will be understood by those skilled in the art that many variations of the embodiment can be made within the scope and spirit of the present invention.

For example, in one variation the ATM marketplace server 5 may be integrated with the server 3 of the issuing bank.

In other variations, the tasks performed by the server 5 and the server 3 may be redistributed between them, leading to a consequent change in the flow of information. For example, the software application may be downloaded from the server 5, rather than the server 3. In another example, the communication device 1 may send the request for currency to the server 5 instead of the server 3, such that the server 5 instructs the server 3 to perform the authorization step.

1. A computerized network for providing physical currency to an individual, the network comprising:
a first communication device associated with the individual, for transmitting a request for physical currency, the request comprising data indicating the amount of physical currency and data specifying a payment account associated with the individual and maintained by an issuing bank;
an issuing bank server associated with the issuing bank and operative, following the request, to perform an authorization process in relation to the payment account and the amount of physical currency; and
a marketplace server arranged:
(a) to search a database of currency providers to identify one or more of the currency providers who meet one or more criteria, the one or more criteria including a criterion of being in a locality of the individual;
(b) to provide to the first communication device details of at least one of the identified currency providers; and
(c) to receive a message indicating that the physical currency has been provided to the individual by one of the identified currency providers;
the issuing bank sever being further arranged to arrange a payment to a receiving bank associated with the one of the identified currency providers.

2. A computerized network according to claim 1 in which the marketplace server is further arranged, prior to providing the first communication device with details of at least one of the identified currency providers, to:
send a message to one or more second communication devices respectively associated with the one or more identified currency providers, the message comprising data specifying the payment amount, and
to receive an acceptance message from at least one of the second communication devices;
said at least one of the identified currency providers being the identified currency providers corresponding to the second communication devices from which the marketplace server received the acceptance message.

3. A computerized network according to claim 1 in which the marketplace server is further arranged:
to provide to the first communication device details of a plurality of the identified currency providers, to receive from the first communication device a selection of one of the identified currency providers, and to send a message to the selected currency provider.

4. A computerized network according to claim 1 in which the issuing bank server and marketplace server are separate servers.

5. A computer program product downloadable into a communication device associated with an individual and comprising at least one data input device, a communication interface, a screen, a processor, and a data storage device for storing the computer program product,
the computer program product comprising program instructions operative by the processor to cause the processor:
in response to first input from the individual using the at least one data input device, to generate and transmit using the communication interface a request for an amount of physical currency, the request comprising data indicating the amount of physical currency and data specifying a payment account associated with an individual and maintained by an issuing bank;
to receive using the communication interface, data specifying one or more currency providers;
to present the data to the individual using the screen; and
to receive a selection from a user of one of the currency providers, and to generate and transmit a message specifying the selected currency provider.

6. A computer program product according to claim 5 in which the programs instructions are further operative to cause the processor to receive second input from the individual indicating the individual has received physical currency from the selected currency provider, and in response to the second input generating and transmitting a message using the communication interface.

7. A method of providing physical currency to an individual, the method comprising:
a first communication device associated with the individual receiving data input from the individual, and in response to the data input transmitting a request for physical currency, the request comprising data indicating the amount of physical currency and data specifying a payment account associated with the individual and maintained by an issuing bank;
an issuing bank server associated with the issuing bank, in response to the request, performing an authorization process in relation to the payment account and the amount of physical currency;
a marketplace server:
(a) searching a database of currency providers to identify one or more of the currency providers who meet one or more criteria, the one or more criteria including a criterion of being in a locality of the individual;
(b) providing to the first communication device details of at least one of the identified currency providers; and
(c) receiving a message indicating that the physical currency has been provided to the individual by one of the identified currency providers;
wherein a payment is made to a payment account associated with the one of the identified currency providers.

8. A method according to claim 7, further including the marketplace server, prior to providing the first communication device with details of at least one of the identified currency providers:
sending a message to one or more second communication devices respectively associated with the one or more identified currency providers, the message comprising data specifying the payment amount, and
receiving an acceptance message from at least one of the second communication devices;
said at least one of the identified currency providers being the identified currency providers corresponding to the second communication devices from which the marketplace server received the acceptance message.

9. A method according to claim 7 further including the marketplace server:
providing to the first communication device details of a plurality of the identified currency providers, receiving from the first communication device a selection of one of the identified currency providers, and sending a message to the selected currency provider.

10. A method according to claim 7 in which the issuing bank server and marketplace server are separate servers.

11. A method according to claim 7 in which the issuing bank server and the marketplace server are operated by separate respective commercial entities.

12. A method according to claim 7 in which the request is sent to the issuing bank server.

13. A method according to claim 7 in which the payment from the issuing bank to the receiving bank is for the amount of physical currency plus a service fee.
